(19) United States
(12) Patent Application Publication
(10) Pub. No.: US 2013/0013163 A1
(43) Pub. Date: Jan. 10, 2013

(54) SYSTEM AND METHOD OF AUTOMATICALLY CONTROLLING THE DISTANCE BETWEEN TWO VEHICLES

(75) Inventor: Wang Gi Hong, Suwon (KR)

(73) Assignee: HYUNDAI MOTOR COMPANY, Seoul (KR)

(21) Appl. No.: 13/305,245

(22) Filed: Nov. 28, 2011

(30) Foreign Application Priority Data
Jul. 5, 2011 (KR) 10-2011-0066489

(51) Int. Cl. B60K 31/00

(52) U.S. Cl. 701/96

(57) ABSTRACT

Disclosed is a technology for a system and a method of automatically controlling a distance between the first vehicle and a second vehicle travelling in front of the first vehicle is provided. The technology includes a camera which captures an image of a road in front of a vehicle, and a control unit which performs predetermined image processing for original image data captured by the camera, determines road conditions using resulting image data, and controls a distance between the first vehicle and a second vehicle travelling in front of the first vehicle based on a determination result.

### CROSS-REFERENCES TO RELATED APPLICATIONS

The priority of Korean patent application No. 10-2011-0066489 filed on Jul. 5, 2011, the disclosure of which is hereby incorporated in its entirety by reference, is claimed.

### BACKGROUND OF THE INVENTION

1. Field of the Invention

The present invention relates to a system and a method of automatically controlling a distance between two vehicles, and more particularly, to a technique of automatically controlling the distance between two vehicles in conjunction with a road condition.

2. Description of the Related Art

A vehicle distance control system is a system that is configured to ensure that the distance between two vehicles is properly maintained by maintaining a predetermined distance between a first vehicle and a second vehicle travelling in front of the first vehicle. Conventional systems measure the distance from the first vehicle to the second vehicle using a radar sensor and control the distance between the first vehicle and the second vehicle so that a preset value or predetermined distance is maintained.

Since friction force between tires and the road is reduced in conditions, a vehicle's breaking distance on a wet road increases in comparison to that on a dry road. However, in the conventional configurations, the breaking distance is predicted on the basis of a dry road regardless road conditions and maintains a constant vehicle distance between the first vehicle and the second vehicle. Thereby, when hard braking in wet conditions, vehicles utilizing the conventional systems are likely to collide with the vehicle in front of them since the distance measurement in these systems is based on dry conditions only.

### SUMMARY OF THE INVENTION

Various aspects of the present invention have been made in view of the above problems, and provide a system and a method of automatically controlling a distance between a first vehicle and a second vehicle travelling in front of the first vehicle based on actual road conditions by determining whether a road is in a dry state or in a wet state due to rain, snow or the any other condition which would hinder the vehicle ability to stop in a normal distance.

According to an aspect of the present invention, a system of automatically controlling a vehicle distance is provided. The system may include a camera which captures a road in front of a vehicle and a control unit which performs predetermined image processing for original image data captured by the camera, determines a road condition using resulting image data, and controls a vehicle distance based on a determination result. The control unit, which may be embodied as a controller, may determine that the road is in a wet state when a band of rainwater or a white component is detected in and from the resulting image data. Furthermore, the camera may be embedded in a lane departure warning system (LDWS).

The control unit may make determinations on whether the road conditions are wet or dry and set a vehicle distance travelling distance on a wet road to be longer than that of a dry road. Additionally, the predetermined image processing may include converting and filtering the original image data.

According to an aspect of the present invention, a method of automatically controlling a vehicle distance is provided. The method may include capturing a road in front of a vehicle while travelling, determining a road condition using resulting image data after predetermined image processing for the captured original image data is performed in advance, and adjusting a vehicle distance according to a determination result.

The systems and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a configuration view illustrating an exemplary system of automatically controlling a vehicle distance according to an exemplary embodiment of the present invention.

FIG. 2 is a flowchart illustrating an exemplary method of automatically controlling a vehicle distance according to the exemplary embodiment of the present invention.

FIG. 3A is a view illustrating an exemplary filtering process for a dry road according to the exemplary embodiment of the present invention.

FIG. 3B is a view illustrating an exemplary filtering process for a wet road due to rain according to the exemplary embodiment of the present invention.

FIG. 3C is a view illustrating an exemplary filtering process for a wet road due to snow according to the exemplary embodiment of the present invention.

FIG. 4A is a view illustrating an exemplary vehicle distance in a dry road according to the exemplary embodiment of the present invention.

FIG. 4B is a view illustrating an exemplary vehicle distance in a wet road according to the exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

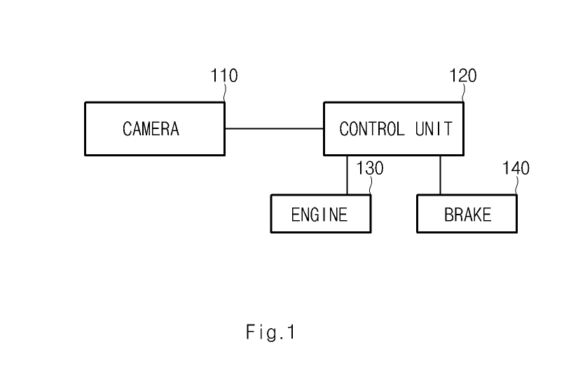

Hereinafter, a system and method of automatically controlling a vehicle distance according to exemplary embodiments of the present invention will be described in more detail with reference to FIGS. 1 to 4B.

FIG. 1 is a configuration view illustrating a system of automatically controlling a vehicle distance according to an exemplary embodiment of the present invention. The system of automatically controlling a vehicle distance according to an exemplary embodiment includes a camera 110, a control unit 120, an engine 130, and a brake 140.

The camera 110 captures a surface of a road in front of a vehicle and transmits image data to the control unit 120. The control unit 120 performs predetermined image processing for the image data received from the camera 110, finds singularity on a screen of resulting image data image-processed, and controls the engine 130 and the brake 140 according to a road condition to adjust a vehicle's distance between itself and a vehicle in front of it. At this time, the predetermined image processing may include converting and filtering original image data and thus a converting and filtering operation will be described as an example of the predetermined image processing.

Although a configuration of the camera and the control unit 120 has been illustrated in the exemplary embodiment, the system may be implemented through and in conjunction with a lane departure warning system (LDWS) and a smart cruise system (SCC). That is, an LDWS may capture road conditions in front of the vehicle using the camera included therein, determine road conditions, and transmit the determination result to the SCC. The SCC then measures the distance between the vehicle in which it is installed and the vehicle in front of it using a radar sensor included therein and controls the engine 130 and the brake 140 according to a determination result of the road condition received from the LDWS to automatically maintain the vehicle distance.

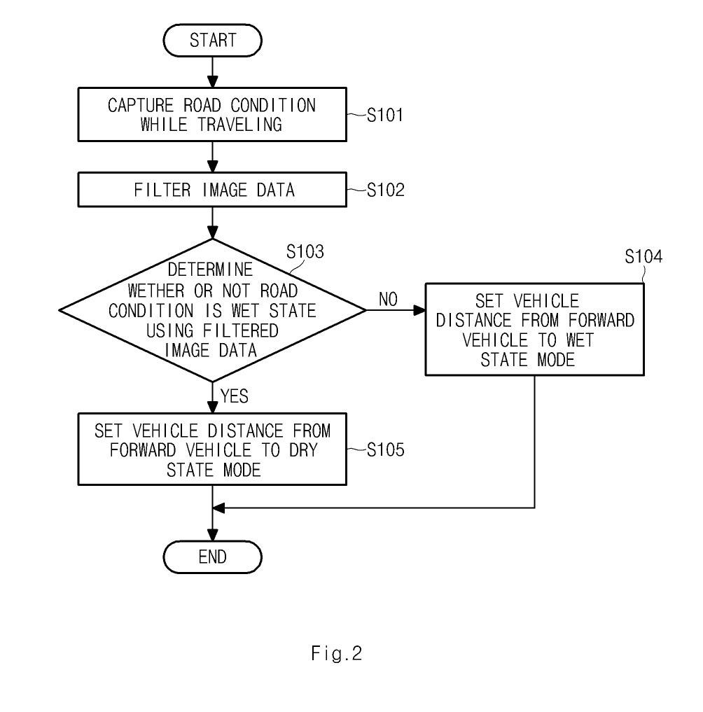

Hereinafter, a method of automatically controlling a vehicle distance according to an exemplary embodiment of the present invention will be described with reference to FIG. 2. First, a road in front of a vehicle is captured using the camera 110 while the vehicle travels along the road (S101). The control unit 120 then converts and filters image data captured by the camera 110 (S102) and determines the road condition using filtered image data. That is, the control unit 120, e.g., a controller or vehicle implemented computer, determines whether the road conditions are wet or dry using the filtered image data (S103).

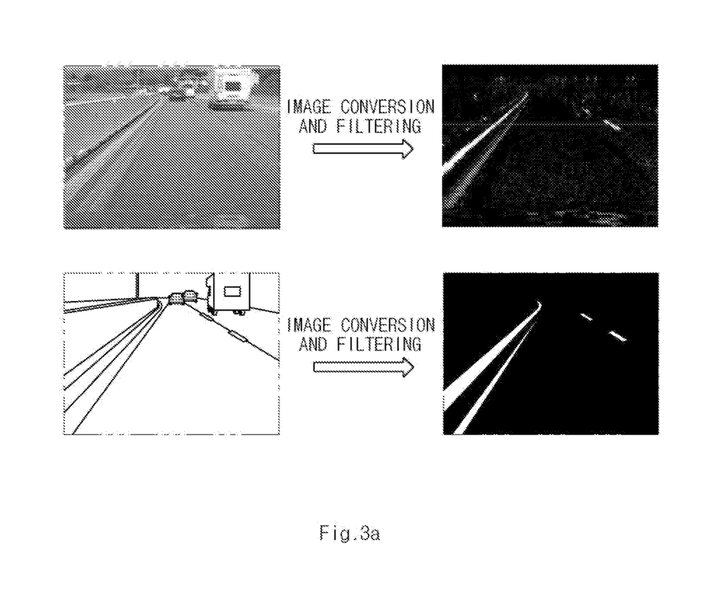

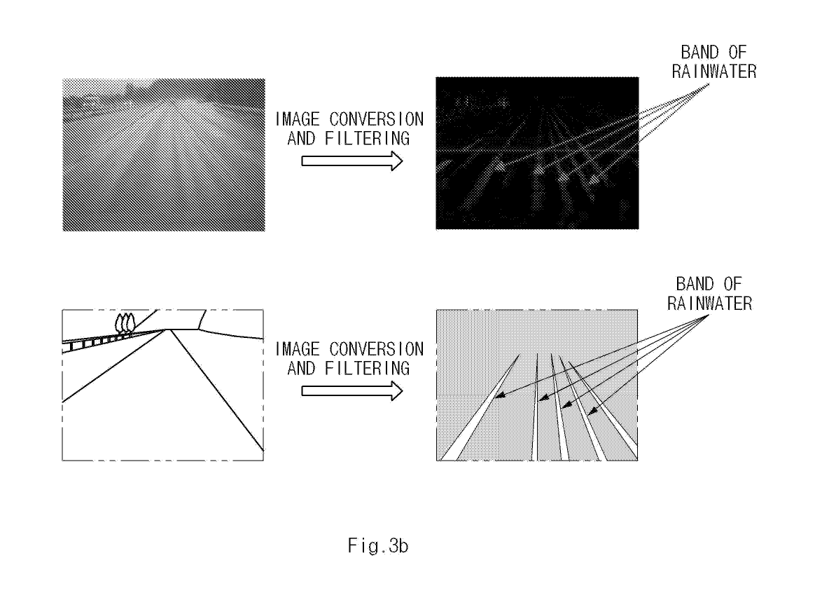

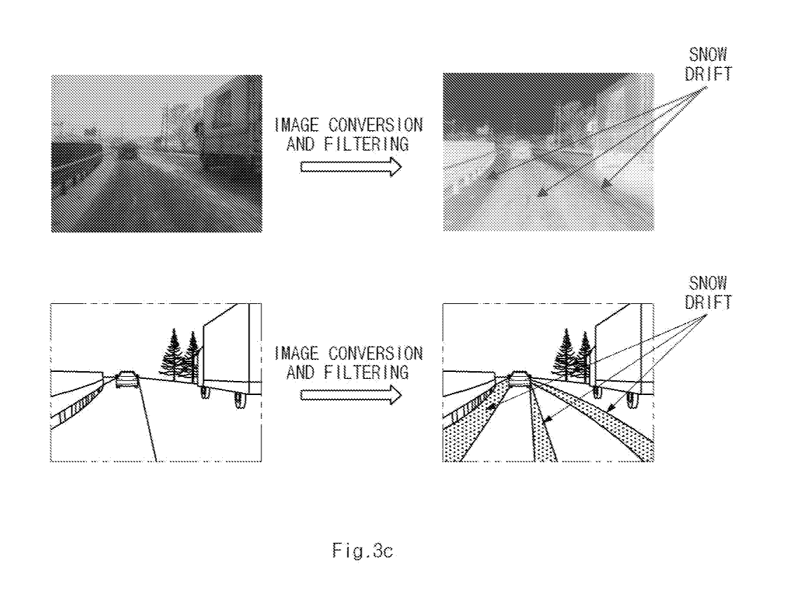

FIG. 3A illustrates a photograph in which a dry road is captured. When the dry road is captured and an image conversion and filtering operation for the dry road captured is performed, there is no singularity in the filtered dry road. If there is no singularity as described above, the control unit 120 determines that the road is dry.

FIG. 3B illustrates a photograph in which a road wetted by rain is captured. When an image conversion and filtering operation for the image of the wet road captured is performed, a band of rainwater is represented in the filtered image data. Therefore, the control unit 120 determines that the road is wet.

FIG. 3C illustrates a photograph in which a road wetted by snow is captured. When an image conversion and filtering operation for the wet road captured is performed, a white component (e.g., snow drift, flakes or accumulation) is represented in the filtered image data so that the control unit 120 determines that the road is wet.

As a result of determination of a procedure S103, when the road is determined wet, the control unit 120 sets the predetermined vehicle distance between the vehicle in which the system is installed and a vehicle travelling in front of it to a wet state mode (S104) and when the road is determined as a dry state, the control unit 120 sets the vehicle distance to a dry state mode (S105).

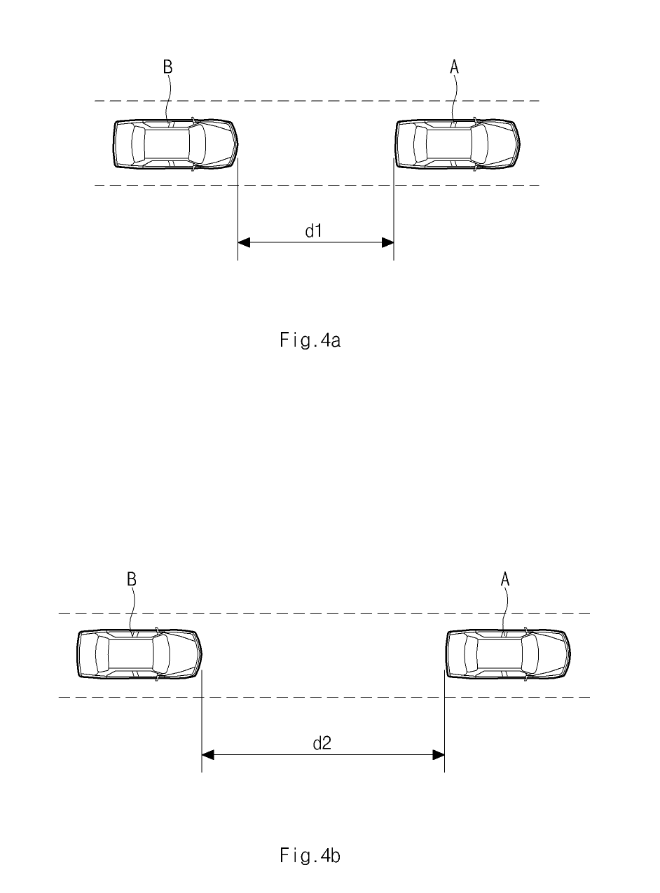

In the dry state mode, as shown in FIG. 4A, a vehicle distance between a backward vehicle B and a forward vehicle A is maintained to a constant distance d1 and in the wet state mode, as shown in FIG. 4B, the vehicle distance between the vehicle B and the vehicle A in front of vehicle B is maintained at a distance d2 which is further than the vehicle distance d1 in the dry state mode.

As described above, the present invention detects whether a road is wet or dry and increases a distance between a first vehicle and a second vehicle travelling in front of the first vehicle when the vehicles are travelling in wet conditions as compared dry conditions so that the risk of a collision caused when hard braking is required can be reduced and vehicular stability can be increased. Therefore, the present invention automatically controls a vehicle distance in conjunction with a road condition so driver convenience can be improved and the risk of car accidents can be minimized.

Furthermore, the present invention may be embodied as computer readable media on a computer readable medium containing executable program instructions executed by a processor on a vehicle implemented computer, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., a telematics network or a controller area network (CAN).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A system of automatically controlling a vehicle distance, the system comprising:
a camera configured to capture an image of a road in front of a first vehicle; and
a control unit configured to perform predetermined image processing for original image data captured by the camera, determine road conditions using resulting image data, and control a distance between the first vehicle and a second vehicle travelling in front of the first vehicle based on a determination result.

2. The system according to claim 1, wherein the control unit is configured to determine that the road is wet when a band of rainwater or a white component is detected from the resulting image data.

3. The system according to claim 1, wherein the camera is embedded in a lane departure warning system (LDWS).

4. The system according to claim 2, wherein the camera is embedded in a LDWS.

5. The system according to claim 1, wherein the control unit determines whether the road conditions are wet or dry and sets a predetermined distance to be maintained between the first vehicle and the second vehicle in wet conditions to be further than that in dry conditions.

6. The system according to claim 2, wherein the control unit determines whether the road conditions are wet or dry and sets a predetermined distance to be maintained between the first vehicle and the second vehicle in wet conditions to be further than that in dry conditions.

7. The system according to claim 1, wherein the predetermined image processing includes converting and filtering the original image data.

8. A method of automatically controlling a vehicle distance, the method comprising:
capturing an image of a road in front of a first vehicle while the vehicle is travelling;
determining road conditions using resulting image data after predetermined image processing for captured original image data is performed in advance; and
adjusting a distance between the first vehicle and a second vehicle travelling in front of the first vehicle according to a determination result.

9. The method according to claim 8, wherein determining further comprises:
determining the road is wet when a band of rainwater or a white component is detected from the resulting image data; and
determining the road is dry when there is no singularity in the resulting image data obtained by performing the predetermined image processing.

10. The method according to claim 8, wherein adjusting further comprises setting the distance between the first vehicle and a second vehicle travelling in front of the first vehicle on a wet road to be further than that on a dry road.

11. The method according to claim 8, wherein the predetermined image processing further comprises converting and filtering the original image data.

12. A computer readable medium containing executable program instructions executed by a controller to automatically controlling a vehicle distance, the method comprising:
program instructions that control a camera to capture an image of a road in front of a first vehicle while the vehicle is travelling;
program instructions that determine road conditions using resulting image data after predetermined image processing for captured original image data is performed in advance; and
program instructions that adjust a distance between the first vehicle and a second vehicle travelling in front of the first vehicle according to a determination result.

13. The method according to claim 12, wherein the program instructions further comprises:
program instructions that determine the road is wet when a band of rainwater or a white component is detected from the resulting image data; and
program instructions that determine the road is dry when there is no singularity in the resulting image data obtained by performing the predetermined image processing.

14. The computer readable medium according to claim 12, program instructions that adjust further comprise program instructions that set the distance between the first vehicle and a second vehicle travelling in front of the first vehicle on a wet road to be further than that on a dry road.

15. The computer readable medium according to claim 12, wherein the predetermined image processing further comprises program instructions that determine convert and filter the original image data.
